(19) United States
(12) Patent Application Publication
(10) Pub. No.: US 2026/0122010 A1
(43) Pub. Date: Apr. 30, 2026

(54) ADDING A POLICY TAG FROM MAPPING INFORMATION

(71) Applicant: HEWLETT PACKARD ENTERPRISE DEVELOPMENT LP, Spring, TX (US)

(72) Inventors: Vikas Kumar Pareek, Bangalore (IN); Somanath Yadavalli, Bangalore (IN); Dhanesh Kumar Shanmuga Sundaram, Bangalore (IN)

(21) Appl. No.: 19/042,218

(22) Filed: Jan. 31, 2025

(30) Foreign Application Priority Data
Oct. 29, 2024 (IN) 202441082611

(51) Int. Cl. H04L 49/00; H04L 12/46; H04L 45/74

(52) U.S. Cl. CPC H04L 49/3009; H04L 12/4633; H04L 45/74

(57) ABSTRACT

In some examples, a border device receives a data packet from a switch in a computing environment, the data packet including a header containing a policy tag indicating a policy to apply to the data packet. The border device stores, in mapping information, the policy tag and routing information in the data packet. The border device sends, to a target device outside the computing environment, a decapsulated packet produced by removing the header from the data packet. The border device receives a response packet sent by the target device, and generates an encapsulated data packet by adding a header to the response packet. The header added to the response packet includes the policy tag retrieved from the mapping information based on routing information in the response packet.

### BACKGROUND

A computing environment includes entities that are able to communicate with one another through various network devices. The computing environment may be a secure environment that is to be protected against unauthorized activities.

### BRIEF DESCRIPTION OF THE DRAWINGS

Some implementations of the present disclosure are described with respect to the following figures.

FIG. 1 is a block diagram of an arrangement including switches and a border device according to some examples.

FIG. 2 is a block diagram of an encapsulated data packet, according to some examples.

FIG. 3 and FIG. 4 are flow diagrams of processes involving an electronic device, an access switch, a border device, and an outside device, according to some examples.

FIG. 5 is a block diagram of a storage medium storing machine-readable instructions according to some examples.

FIG. 6 is a block diagram of a border device according to some examples.

FIG. 7 is a flow diagram of a process according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

A computing environment can be divided into multiple segments that are associated with respective policies that govern activities in the respective segments. This type of segmentation can be referred to as micro-segmentation. Segmentation of the computing environment may be achieved by assigning entities (e.g., users, programs, and/or machines) to different groups, where each group of entities is associated with a respective group-based policy. A group-based policy can include a security policy that specifies resources that entities of a given group are permitted to access, or actions that such entities may take. A group-based policy may also specify other rules that govern the operations of entities.

To support the use of group-based policies for respective groups of entities, policy tags can be added to headers of data packets. A group-based policy (GBP) tag can indicate which group-based policy (or set of group-based policies) is to be applied for a given communication between entities. A header of a data packet that includes a GBP tag may be a virtual tunnel header that is associated with a virtual tunnel through which the data packet is transferred. A tunneling endpoint of the virtual tunnel in the computing environment may encapsulate a data packet by adding the virtual tunnel header, which contains the GBP tag. However, if the encapsulated data packet is to exit the computing environment, a border device in the computing environment decapsulates the encapsulated data packet by removing the virtual tunnel header, and the border device sends the decapsulated data packet to a target device outside the computing environment. The target device sends a response packet back to the computing environment as a response to the decapsulated data packet. Because the GBP tag was removed from the decapsulated data packet sent to the target device, the response packet does not include the GBP tag. Network devices in the computing environment would thus not be able to apply a group-based policy to the response packet since the GBP tag is missing, which raises a security risk for the computing environment. For example, failure to apply a group-based policy may result in an entity gaining unauthorized access to protected data or a protected segment of the computing environment, or the entity having an ability to initiate an unauthorized operation in the computing environment that can lead to faults or errors.

In accordance with some implementations of the present disclosure, segmentation of a computing environment based on group-based policies is preserved by retaining GBP tags at a border device for data packets exiting the computing environment. The GBP tags are retained in GBP tag mapping information at the border device, where the GBP tag mapping information correlates GBP tags observed at the border device to routing information. The border device receives, from a switch in the computing environment, a data packet encapsulated with a virtual tunnel header containing a GBP tag indicating a policy to apply to the data packet. The data packet received by the border device is to exit the computing environment. The border device decapsulates the data packet to remove the virtual tunnel header. The border device further stores, in an entry of the GBP tag mapping information, the GBP tag and routing information in the data packet. The routing information can include, as examples, a source network address and a routing domain. The decapsulated data packet is sent by the border device to a target device outside the computing environment. The target device sends a response packet to the border device. The border device generates an encapsulated data packet by adding a virtual tunnel header to the response packet, where the virtual tunnel header added to the response packet includes the GBP tag retrieved from the mapping information based on routing information in the response packet.

The ability to add the GBP tag to the response packet at the border device allows for the group-based policy indicated by the GBP tag to be applied to the response packet. As a result, rules of the group-based policy may be enforced against the response packet, which can enhance security and reduce the likelihood of data breaches. Also, the ability to retain GBP tags for communications between the computing environment and target devices outside the computing environment allows for respective group-based policies to be applied, thereby maintaining micro-segmentation.

A “border device” refers to a network device that is provided at a boundary of a computing environment, such that any data packet that egresses the computing environment passes through the border device, and any data packet received from outside the computing environment also passes through the border device. A “switch” refers to a network device that forwards data packets along network paths based on network addresses contained in the data packets. A “data packet” refers to any unit of information that can be sent separately from any other unit of information. A “tag” refers to an information element that can be set to a value (selected from among multiple possible values). The information element can include one or more data bits.

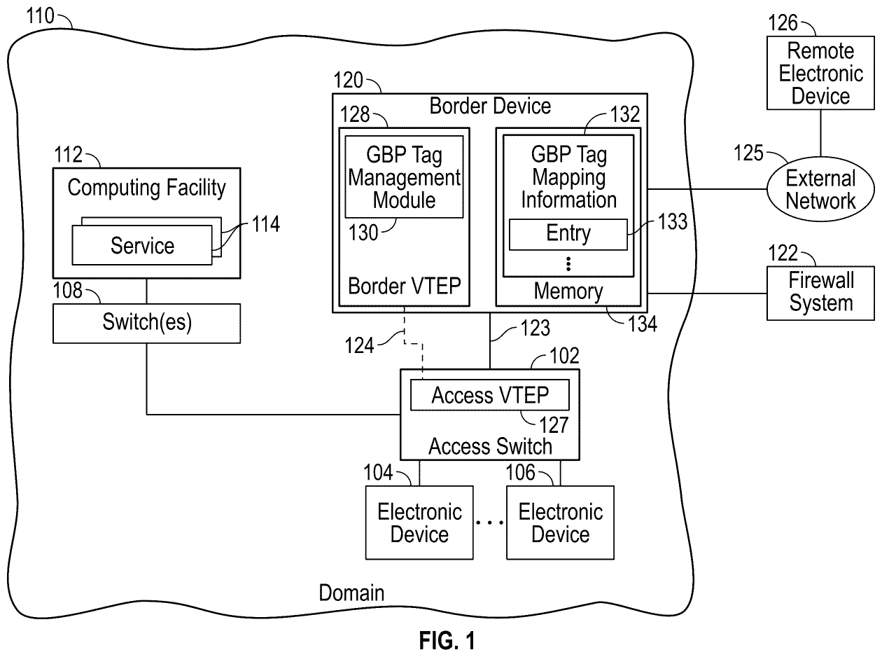

FIG. 1 is a block diagram of an example arrangement that includes an access switch 102 connected to various electronic devices 104 and 106. An “access switch” refers to a switch that an electronic device uses to access a network. The access switch 102 can be connected to one or more other switches 108 of a domain 110. The other one or more switches 108 can include other access switches or intermediate switches that can interconnect access switches to other systems.

A “domain” can refer to a campus, a geographic site, a communication fabric, or any other type of computing environment. Electronic devices in the domain 110 can communicate with other electronic devices in the same domain (or with services in the domain 110), or with electronic devices outside the domain 110.

The domain 110 further includes a computing facility 112, such as a data center, a cloud environment, a collection of servers, or another type of computing facility. The computing facility 112 provides services 114 that are accessible by electronic devices, including the electronic devices 104 and 106 in the domain 110. Examples of the services 114 include any or some combination of the following: application services, web services, storage services, communication services, virtual machine as a service (VMaaS), bare-metal (BM) as a service (BmaaS), or other types of services.

To communicate with electronic devices outside the domain 110, traffic is passed through a border device 120. The domain 110 may include multiple border devices in further examples. Examples of external devices outside the domain 110 include a firewall system 122, a remote electronic device 126 coupled to the domain 110 through an external network 125, or any other type of electronic device that is outside the domain 110. Note that multiple remote electronic devices may be connected to the external network 125. In the example of FIG. 1, the border device 120 is connected to the firewall system 122 and the external network 125.

The firewall system 122 enforces security rules for data transferred from or to an entity in the domain 110. The firewall system 122 processes data packets as the data packets ingress or egress the domain 110 to prevent data packets that violate security rules from being transferred. More generally, the firewall system 122 is an example of a network security device to apply security rules to block harmful traffic or activities.

The access switch 102 is connected over a communication link 123 to the border device 120. In some examples, a virtual tunnel 124 can be established between the access switch 102 and the border device 120. The virtual tunnel 124 is used to carry data packets exchanged between the electronic devices 104, 106 and other entities, which may be outside the domain 110 or inside the domain 110.

In some examples, a virtual tunnel includes a Virtual Extensible Local Area Network (VXLAN) tunnel. According to the VXLAN protocol, a VXLAN tunnel encapsulates Layer 2 frames of a Layer 2 overlay network as payloads in Layer 3 packets. The Layer 3 packets are communicated through a Layer 3 underlay network. A network in which frames of a Layer 2 overlay network are carried over a Layer 3 underlay network is referred to as an “underlay and overlay network.” An example of the Layer 3 underlay network is an Internet Protocol (IP) network that transfers data in data packets. An example of the Layer 2 overlay network is an Ethernet network that transfers data in Ethernet frames. In such examples, the VXLAN tunnel can encapsulate an Ethernet frame as a payload in an IP data packet.

More generally, a virtual tunnel can carry data according to a first communication protocol as payload within a data packet of a different second communication protocol. A “virtual tunnel” can refer to a communication path over a network in which data packets are encapsulated before being transmitted.

A network device, such as a switch or another type of network device that forwards data, can include a data plane entity that performs VXLAN encapsulation and decapsulation. Such a data plane entity is referred to as a VXLAN tunnel endpoint (VTEP). The VTEP is part of the data plane of the underlay and overlay network used for forwarding data by the network device. The network device also includes a control plane entity (that is part of a control plane of the underlay and overlay network) that exchanges control information with other network devices to enable forwarding of data by the network devices. In some examples, the control plane of the underlay and overlay network can operate according to the Ethernet Virtual Private Network (EVPN) technology.

In examples that implement EVPN and VXLAN, the different domains of a network environment can include different EVPN domains. Although reference is made to EVPN and VXLAN in some examples for establishing virtual tunnels between network devices, it is noted that in other examples, other types of virtual tunnel technologies may be employed, whether open source, standardized, or proprietary. Examples of other virtual tunnel technologies include the following: a Multiprotocol Label Switching (MPLS)-over-Generic Routing Encapsulation (GRE) technology, a Network Virtualization using GRE (NVGRE) technology, or any other technology for establishing virtual tunnels.

As shown in FIG. 1, the access switch includes a VTEP 127 (referred to as an “access VTEP”), and the border device includes a VTEP 128 (referred to as a “border VTEP”). The VTEPs 127 and 128 can exchange encapsulated data packets through the virtual tunnel 124, such as a VXLAN tunnel.

The following describes an example in which the electronic device 104 sends a data packet that is targeted to a destination entity, where the destination entity may be inside or outside the domain 110. The destination entity can be another device in the domain 110, a service 114 in the computing facility 112, or a device outside the domain 110.

In a first example scenario, the data packet is sent from the electronic device 104 to the remote electronic device 126 connected to the external network 125. In a second example scenario, the electronic device 104 can belong to a guest user that is a guest of the domain 110. In the second example scenario, communications of the electronic device 104 associated with the guest user may not be trusted. As a result, data packets sent by the electronic device 104 associated with the guest user would be forwarded to the firewall system 122 to apply security rules to ensure that the traffic of the guest user is authorized in the domain 110.

In either the first or second example scenario noted above, the data packet sent by the electronic device 104 is passed to an outside device that is external of the domain 110. The outside device is the remote electronic device 126 in the first example scenario, and the outside device is the firewall system 122 in the second example scenario. There are other scenarios in which a data packet sent by an electronic device in the domain 110 is passed to an outside device external of the domain 110.

In any scenario in which a data packet from an electronic device in the domain 110 is passed to an outside device, the data packet is encapsulated by adding a virtual tunnel header, and the encapsulated data packet is sent over a virtual tunnel to a border device (such as the virtual tunnel 124 to the border device 120).

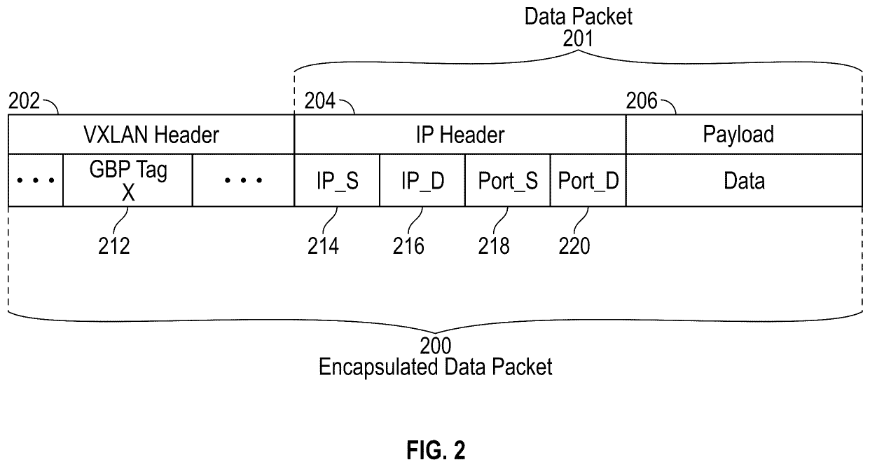

The following refers to both FIG. 1 and FIG. 2. FIG. 2 shows an example encapsulated data packet 200. When the access switch 102 receives a data packet 201 from the electronic device 104, the access VTEP 127 in the access switch 102 encapsulates the data packet 201 by adding a virtual tunnel header, such as a VXLAN header 202. Adding the VXLAN header 202 to the data packet 201 forms the encapsulated data packet 200. The data packet 201 includes an IP header 204 and a payload 206 (that contains data to be communicated). The IP header 204 is an example of an inner header of the encapsulated data packet 200.

The added VXLAN header 202 includes a GBP tag field 212 that contains a GBP tag (e.g., “GBP tag X”) that identifies a group-based policy to be applied in a communications session that includes the data packet 201 sent by the electronic device 104. The encapsulated data packet 200 is sent through the virtual tunnel 124 (e.g., a VXLAN tunnel) to the border VTEP 128 in the border device 120.

The border VTEP 128 decapsulates the encapsulated data packet 200 by removing the VXLAN header 202, which produces a decapsulated data packet (the data packet 201) that does not include the VXLAN header 202 received from the access VTEP 127. As a result, the decapsulated data packet does not contain GBP tag X. The border VTEP 128 sends the data packet 201 (after decapsulation) to the outside device, such as the firewall system 122 or the remote electronic device 126.

In conjunction with decapsulating the encapsulated data packet 200, a GBP tag management module 130 in the border VTEP 128 extracts GBP tag X from the VXLAN header 202 for the purpose of preserving GBP tag X. In some examples, the GBP tag management module 130 can be implemented with machine-readable instructions executed by a processing resource of the border device 120. In other examples, the GBP tag management module 130 can be implemented with one or more hardware processing circuits of the border device 120. Although shown as being part of the border VTEP 128 in FIG. 1, in alternative examples, the GBP tag management module 130 may be separate from the border VTEP 128.

The GBP tag management module 130 also retrieves packet routing information from the data packet 201. The packet routing information can be part of the IP header 204 of the data packet 201. The IP header 204 includes a source IP field 214 and a destination IP field 216. The source IP field 214 contains a source IP address (e.g., IP_S) that identifies the source of the data packet 201, and the destination IP field 216 contains a destination IP address (e.g., IP_D) that identifies the destination of the data packet 201. The source is the electronic device 104, and the destination is the destination entity to which the data packet 201 is targeted.

The IP header 204 may further include a source port field 218 that contains a source port number (e.g., Port_S), and a destination port field 220 that contains a destination port number (e.g., Port_D). In some examples, the port numbers can identify Transmission Control Protocol (TCP) ports. In other examples, the port number can identify User Datagram Protocol (UDP) ports.

The packet routing information retrieved by the GBP tag management module 130 from the data packet 201 includes IP_S in the source IP field 214. In some examples, the packet routing information retrieved by the GBP tag management module 130 from the data packet 201 may further include Port_S in the source port field 218.

In other examples, the data packet 201 may include other header information (whether part of the IP header 204 or part of another header) that contains further information that can be extracted for inclusion in the packet routing information retrieved by the GBP tag management module 130.

The GBP tag management module 130 adds an entry 133 to GBP tag mapping information 132 stored in a memory 134 of the border device 120. The added entry 133 can be later used to restore the GBP tag (e.g., GBP tag X) for the communications session that includes the data packet 201. The entry 133 correlates packet routing information to GBP tag X. For example, the entry 133 may correlate IP_S (the IP address extracted from the source IP field 214) to GBP tag X. In further examples, the entry 133 may correlate the combination of IP_S (the IP address extracted from the source IP field 214) and Port_S (the port number extracted from the source port field 218) to GBP tag X. In other examples, the entry 133 may correlate other packet routing information to GBP tag X.

The GBP tag mapping information 132 can include multiple entries that correlate different packet routing information (e.g., different IP addresses or different combinations of IP addresses and port numbers) to respective different GBP tags. In some examples, the GBP tag mapping information 132 can be in the form of a table. In other examples, the GBP tag mapping information 132 can be a different type of data structure, such as a text file, a tree, and so forth.

When the GBP tag management module 130 receives a response packet (that is a response to the data packet 201) from the outside device, the GBP tag management module 130 uses packet routing information in the response packet to look up an entry of the GBP tag mapping information 132. The packet routing information maps into an entry of the GBP tag mapping information 132, and the mapped entry contains GBP tag X.

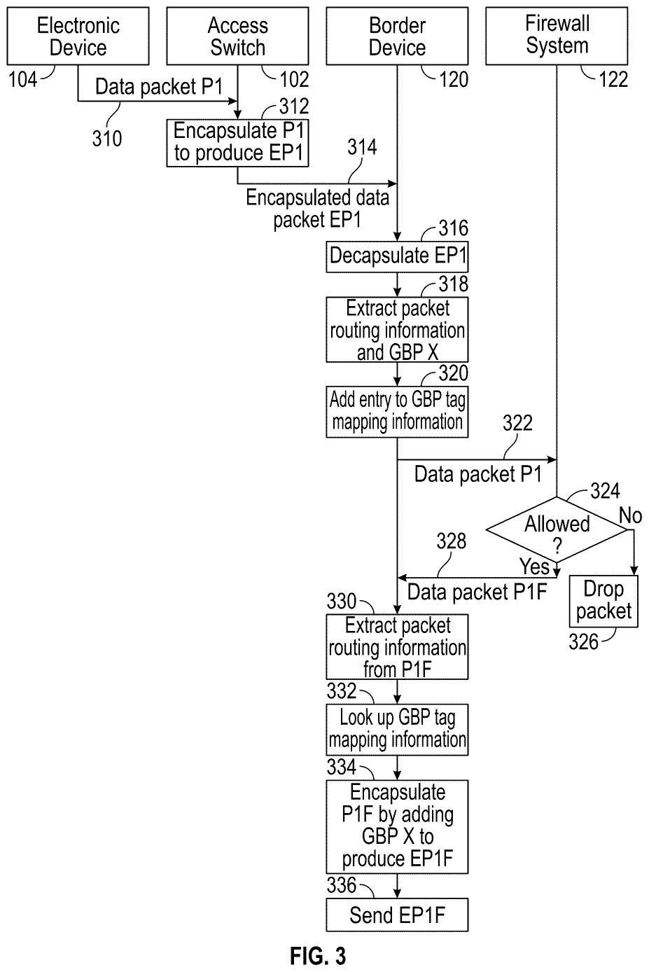

FIG. 3 is a flow diagram of a process involving the electronic device 104, the access switch 102, the border device 120, and the firewall system 122. The electronic device 104 is an origin electronic device that sends (at 310) data packet P1 (e.g., 201 in FIG. 2) to the access switch 102. In the example of FIG. 3, the sending of data packet P1 involves the firewall system 122 applying a security rule to determine whether transmission of data packet P1 is allowed. One example of this scenario is where the electronic device 104 is associated with a guest user of the domain 110.

In response to receiving data packet P1 at the access switch 102, the access VTEP 127 in the access switch 102 encapsulates (at 312) data packet P1 by adding a VXLAN header (e.g., 202 in FIG. 2) containing GBP tag X that identifies a group-based policy for a communications session including data packet P. The encapsulation produces an encapsulated data packet EP1.

The access VTEP 127 sends (at 314) encapsulated data packet EP1 (e.g., 200 in FIG. 2) over the VXLAN tunnel 124 to the border device 120. The border VTEP 128 in the border device 120 decapsulates (at 316) the received encapsulated data packet EP1, which produces a decapsulated data packet (P1). Also, the GBP tag management module 130 in the border device 120 extracts (at 318) the following pieces of information from the received encapsulated data packet EP1: GBP tag X and packet routing information. In some examples, the packet routing information extracted includes the IP address (e.g., IP_S) of the electronic device 104 from the source IP field (e.g., 214 in FIG. 2) of data packet P1. In other examples, the packet routing information extracted further includes a port number (e.g., Port_S) of a port of the electronic device 104 from the source port field (e.g., 218 in FIG. 2) of data packet P1. In additional examples, the packet routing information may include additional or alternative information that can be extracted from data packet P1.

In the ensuing discussion, it is assumed that the extracted packet routing information includes the IP address and the port number (e.g., IP_S and Port_S) for the electronic device 104. The GBP tag management module 130 adds (at 320) an entry (e.g., 133 in FIG. 1) to the GBP tag mapping information 132, where the added entry correlates GBP tag X to the packet routing information (IP_S and Port_S).

After decapsulation of encapsulated data packet EP1 by the border VTEP 128 in the border device 120, the border device 120 sends (at 322) the decapsulated data packet (P1) to the firewall system 122. The firewall system 122 applies a security rule with respect to the data packet 201, to determine (at 324) whether or not forwarding of the data packet 201 to the destination entity is allowed. If the firewall system 122 determines (at 324) based on the security rule that forwarding of the data packet 201 is not permitted, the firewall system 122 drops (at 326) the data packet 201, and the firewall system 122 returns an error indication to the border device 120.

However, if the firewall system 122 determines (at 324) based on the security rule that forwarding of the data packet 201 is allowed, the firewall system 122 sends (at 328) data packet P1F to the border device 120. Data packet P1F is the copy of data packet P1 transmitted by the firewall system 122.

In response to data packet P1F from the firewall system 122, the GBP tag management module 130 extracts (at 330) packet routing information from data packet P1F (e.g., IP_S and Port_S from the source IP field and source port field of data packet P1F). The GBP tag management module 130 performs a lookup (at 332) of the GBP tag mapping information 132 using the packet routing information extracted from P1F. The entry identified in the lookup correlates the extracted packet routing information to GBP X. The border VTEP 128 in the border device 120 encapsulates (at 334) data packet P1F by adding a VXLAN header including GBP tag X, which produces encapsulated data packet EP1F. The border device 120 then sends (at 336) encapsulated data packet EP1F (with the VXLAN header including GBP tag X) to another switch, for forwarding to the destination entity. The switch to which encapsulated data packet EP1F is sent may apply a group-based policy identified by GBP X in the VXLAN header of encapsulated data packet EP1F.

FIG. 4 is a flow diagram of a process involving the electronic device 104, the access switch 102, the border device 120, and the remote electronic device 126. In the example of FIG. 4, data packet P1 sent by the electronic device 104 is targeted to the remote electronic device 126.

Tasks 410, 412, 414, 416, 418, and 420 are similar to respective tasks 310, 312, 314, 316, 318, and 320 of FIG. 3. After decapsulation of encapsulated data packet EP1 by the border VTEP 128 in the border device 120, the border device 120 sends (at 422) the decapsulated data packet (P1) to the remote electronic device 126.

In response to data packet P1, the remote electronic device 126 sends (at 424) a response packet RP1 to the border device 120. In this example, the IP header of response packet RP1 includes a source IP field containing an IP address of the remote electronic device 126, and a destination IP field containing the IP address (e.g., IP_S) of electronic device 104. Similarly, the IP header of response packet RP1 includes a source port field containing a port number for a port of the remote electronic device 126, and a destination port field containing the port number (e.g., Port_S) of a port of the electronic device 104.

Upon receiving response packet RP1 from the remote electronic device 126, the GBP tag management module 130 extracts (at 426) packet routing information (e.g., IP_S and Port_S) from the destination IP field and the destination port field of response packet RP1. The GBP tag management module 130 performs a lookup (at 428) of the GBP tag mapping information 132 using the packet routing information extracted from response packet RP1. The entry identified in the lookup correlates the extracted packet routing information to GBP X. The border VTEP 128 in the border device 120 encapsulates (at 430) response packet RP1 by adding a VXLAN header including GBP tag X, which produces encapsulated response packet ERP1. The border device 120 then sends (at 432) encapsulated response packet ERP1 (with the VXLAN header including GBP tag X) to the access switch 102.

The access switch 102 applies (at 434) a group-based policy identified by GBP X in the VXLAN header of encapsulated response packet ERP1. Assuming the group-based policy is not violated, the access VTEP 127 in the access switch 102 decapsulates (at 436) encapsulated response packet ERP1 to produce decapsulated response packet (RP1). The access switch 102 sends (at 438) response packet RP1 to the electronic device 104.

The GBP tag management module 130 performs a lookup of the GBP tag mapping information 132 using the retrieved packet routing information from the response packet. The entry identified in the lookup correlates the retrieved packet routing information to GBP X. The border VTEP 128 in the border device 120 encapsulates the response packet by adding a VXLAN header including GBP tag X. The border device 120 then forwards the encapsulated response packet (with the VXLAN header including GBP tag X) to the destination entity.

In some examples of the present disclosure, the GBP tag management module 130 is able to preserve a GBP tag carried by an encapsulated data packet received over a virtual tunnel. The preserved GBP tag (stored in an entry of the GBP tag mapping information 132) can be used to populate a virtual tunnel header when the border device 120 later encapsulates a response packet received from an outside device. In this manner, the appropriate group-based policy (as indicated by the GBP tag) can be applied to the response packet to ensure secure communications in the domain 110.

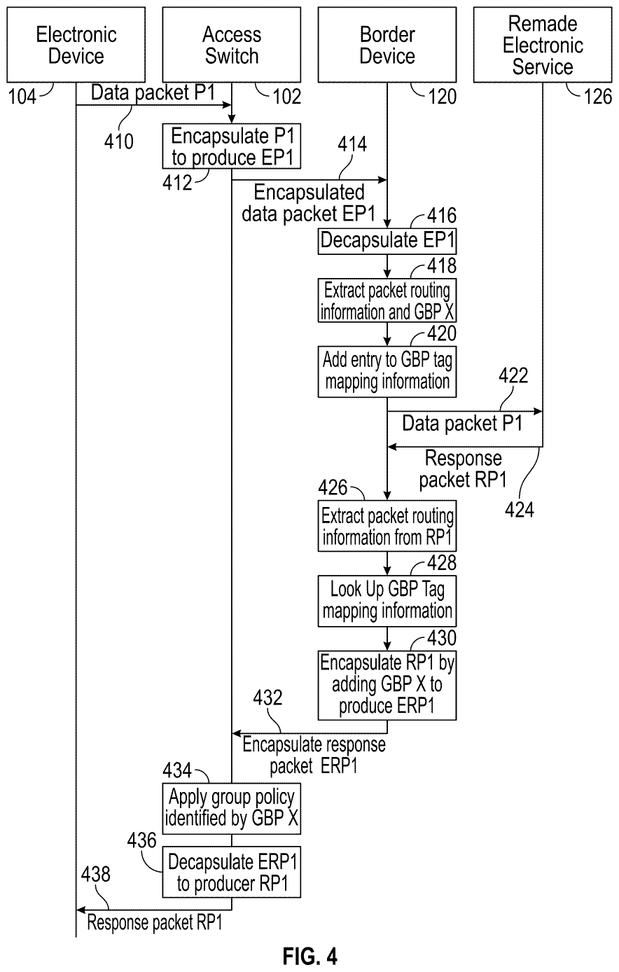

FIG. 5 is a block diagram of a non-transitory machine-readable or computer-readable storage medium 500 storing machine-readable instructions that upon execution cause a border device of a computing environment to perform various tasks. An example of the computing environment is the domain 110 of FIG. 1. An example of the border device is the border device 120 of FIG. 1.

The machine-readable instructions include data packet reception instructions 502 to receive, at the border device, a data packet from a switch in the computing environment, the data packet including a header containing a policy tag indicating a policy to apply to the data packet. An example of the switch is the access switch 102 of FIG. 1. An example of the header is a VXLAN header.

The machine-readable instructions include mapping information update instructions 504 to store, in mapping information, the policy tag and routing information in the data packet. An example of the mapping information is the GBP tag mapping information 132 of FIG. 1. An example of the policy tag is a GBP tag. The routing information may include an IP address of a source entity that sent data encapsulated by the switch to produce the data packet. In further examples, the routing information may include a port number (e.g., TCP port number, UDP port number, etc.) for the source entity.

The machine-readable instructions include decapsulated packet sending instructions 506 to send, from the border device to a target device outside the computing environment, a decapsulated packet produced by removing the header from the data packet. The target device may include a firewall system or a remote electronic device connected to an external network.

The machine-readable instructions include response packet reception instructions 508 to receive, at the border device, a response packet sent by the target device. The response packet may be sent by the firewall system or the remote electronic device.

The machine-readable instructions include encapsulated data packet generation instructions 510 to generate an encapsulated data packet by adding a header to the response packet. The header added to the response packet includes the policy tag retrieved from the mapping information based on routing information in the response packet.

The machine-readable instructions include encapsulated data packet transmission instructions 512 to transmit, from the border device, the encapsulated data packet to a destination entity. The destination entity may be the source entity or another entity.

In some examples, the policy tag is included in the virtual tunnel header of the data packet, and the routing information is included in an inner header of the data packet.

In some examples, the inner header includes an IP header, and the routing information in the IP header includes a source IP address of a source entity that transmitted data encapsulated by the switch to form the data packet.

In some examples, the switch is an access switch connected over a virtual tunnel to the border device, and the virtual tunnel header of the data packet from the access switch is associated with the virtual tunnel.

In some examples, the target device includes a firewall system, and the response packet is the decapsulated packet returned by the firewall system to the border device.

In some examples, the target device includes a remote electronic device outside the computing environment, and the response packet is sent by the remote electronic device as a response to the decapsulated packet.

In some examples, the routing information in the data packet includes a source network address of a source entity that transmitted data encapsulated by the switch to form the data packet. The border device adds an entry to the mapping information, where the entry correlates the policy tag to the source network address.

In some examples, the policy tag in the encapsulated data packet sent to the destination entity is for use by a switch in applying the policy with respect to a communication including the encapsulated data packet.

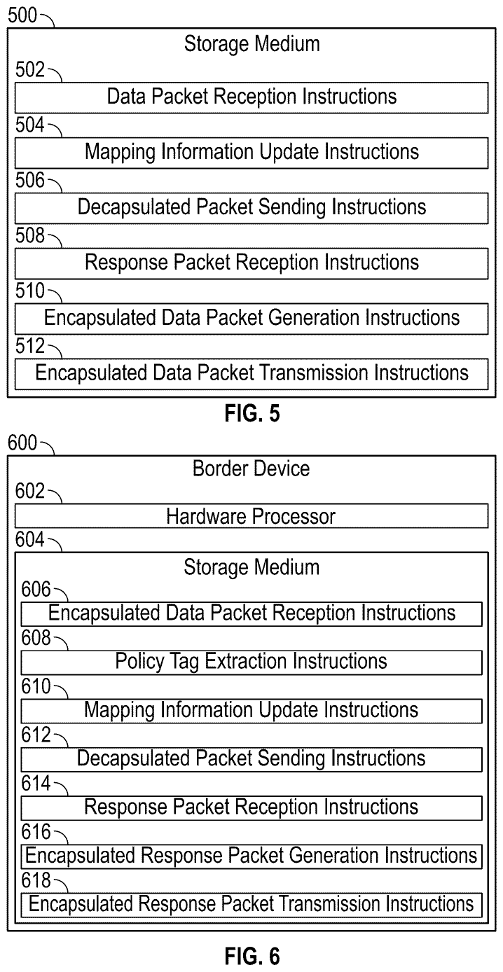

FIG. 6 is a block diagram of a border device 600 according to some examples. The border device 600 may be the border device 120 of FIG. 1.

The border device 600 includes a hardware processor 602 (or multiple hardware processors). A hardware processor can include a microprocessor, a core of a multi-core microprocessor, a microcontroller, a programmable integrated circuit, a programmable gate array, or another hardware processing circuit.

The border device 600 includes a storage medium 604 storing machine-readable instructions executable on the hardware processor 602 to perform various tasks. Machine-readable instructions executable on a hardware processor can refer to the instructions executable on a single hardware processor or the instructions executable on multiple hardware processors.

The machine-readable instructions in the storage medium 604 include encapsulated data packet reception instructions 606 to receive, at the border device, an encapsulated data packet from a switch in a computing environment. The encapsulated data packet includes a virtual tunnel header containing a policy tag indicating a policy to apply to the encapsulated data packet.

The machine-readable instructions in the storage medium 604 include policy tag extraction instructions 608 to extract, at the border device, the policy tag from the virtual tunnel header and routing information from an inner header of the encapsulated data packet. The virtual tunnel may be a VXLAN header, and the inner header may be an IP header.

The machine-readable instructions in the storage medium 604 include mapping information update instructions 610 to add an entry to mapping information, the entry correlating the policy tag to the routing information. An example of the mapping information is the GBP tag mapping information 132 of FIG. 1.

The machine-readable instructions in the storage medium 604 include decapsulated packet sending instructions 612 to send, from the border device to a target device outside the computing environment, a decapsulated packet produced by removing the virtual tunnel header from the encapsulated data packet.

The machine-readable instructions in the storage medium 604 include response packet reception instructions 614 to receive, at the border device, a response packet sent by the target device. The response packet may be sent by a firewall system or a remote electronic device outside the computing environment.

The machine-readable instructions in the storage medium 604 include encapsulated response packet generation instructions 616 to generate an encapsulated response packet by adding a virtual tunnel header to the response packet. The virtual tunnel header added to the response packet includes the policy tag retrieved from the entry of the mapping information based on routing information in the response packet.

The machine-readable instructions in the storage medium 604 include encapsulated response packet transmission instructions 618 to transmit, from the border device, the encapsulated response packet to a destination entity.

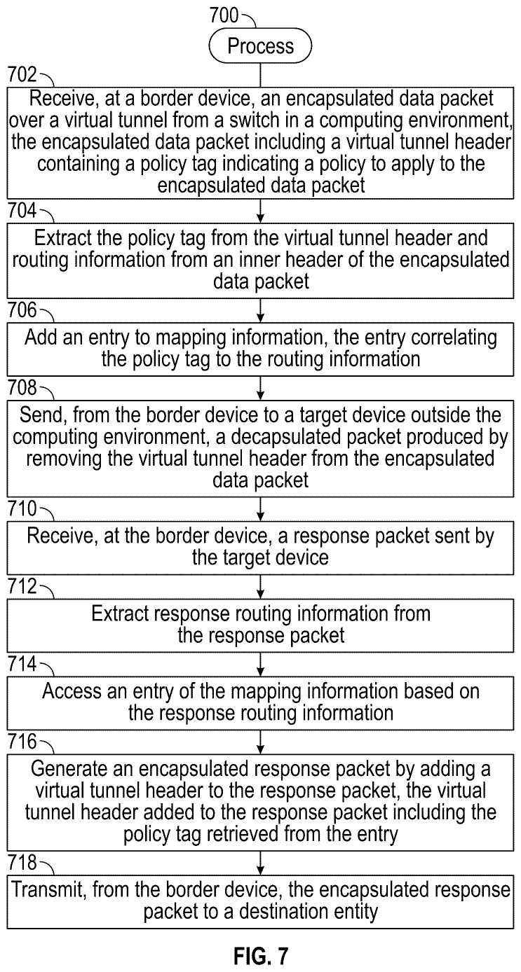

FIG. 7 is a flow diagram of a process 700 according to some examples of the present disclosure. In some examples, the process 700 may be performed by a border device, such as the border device 120 of FIG. 1 or the border device 600 of FIG. 6.

The process 700 includes receiving (at 702), at a border device, an encapsulated data packet over a virtual tunnel from a switch in a computing environment, the encapsulated data packet including a virtual tunnel header containing a policy tag indicating a policy to apply to the encapsulated data packet. The policy tag may be a GBP tag, for example.

The process 700 includes extracting (at 704) the policy tag from the virtual tunnel header and routing information from an inner header of the encapsulated data packet. The inner header may include an IP header and possibly other headers.

The process 700 includes adding (at 706) an entry to mapping information, the entry correlating the policy tag to the routing information. The mapping information can include multiple entries mapping different policy tags to different respective routing information.

The process 700 includes sending (at 708), from the border device to a target device outside the computing environment, a decapsulated packet produced by removing the virtual tunnel header from the encapsulated data packet. The target device may be a firewall system or a remote electronic device, for example.

The process 700 includes receiving (at 710), at the border device, a response packet sent by the target device. The response packet may be the decapsulated packet sent by the firewall system, or a different packet sent by the remote electronic device.

The process 700 includes extracting (at 712) response routing information from the response packet. The response routing information can include an IP address and possibly other information.

The process 700 includes accessing (at 714) the entry of the mapping information based on the response routing information. The entry is accessed based on a lookup of the mapping information using the response routing information.

The process 700 includes generating (at 716) an encapsulated response packet by adding a virtual tunnel header to the response packet, the virtual tunnel header added to the response packet including the policy tag retrieved from the entry.

The process 700 includes transmitting (at 718), from the border device, the encapsulated response packet to a destination entity.

In some examples, an “electronic device” may include a desktop computer, a notebook computer, a tablet computer, a smartphone, a game appliance, an Internet-of-Things (IoT) device, or any other type of device. A “memory” can be implemented with one or more memory devices, such as a dynamic random access memory (DRAM) device, a static random access memory (SRAM) device, an erasable and programmable read-only memory (EPROM) device, an electrically erasable and programmable read-only memory (EEPROM) device, or a flash memory device. A “processing resource” can include one or more hardware processors.

Although FIGS. 3, 4, and 7 show processes including tasks in certain orders, in other examples, the tasks of the processes may be performed in a different order, some tasks may be omitted, and other tasks may be added.

A storage medium (e.g., 500 in FIG. 5 or 604 in FIG. 6) can include any or some combination of the following: a semiconductor memory device such as a DRAM or SRAM device, an EPROM device, an EEPROM device, or a flash memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a border device of a computing environment to:
receive, at the border device, a data packet from a switch in the computing environment, the data packet comprising a header containing a policy tag indicating a policy to apply to the data packet;
store, in mapping information, the policy tag and routing information in the data packet;
send, from the border device to a target device outside the computing environment, a decapsulated packet produced by removing the header from the data packet;
receive, at the border device, a response packet sent by the target device;
generate an encapsulated data packet by adding a header to the response packet, the header added to the response packet comprising the policy tag retrieved from the mapping information based on routing information in the response packet; and
transmit, from the border device, the encapsulated data packet to a destination entity.

2. The non-transitory machine-readable storage medium of claim 1, wherein the header of the data packet and the header added to the response packet comprise virtual tunnel headers.

3. The non-transitory machine-readable storage medium of claim 2, wherein the virtual tunnel headers comprise Virtual extensible LAN (VXLAN) headers, and the policy tag comprises a group-based policy (GBP) tag.

4. The non-transitory machine-readable storage medium of claim 2, wherein the policy tag is included in the virtual tunnel header of the data packet, and the routing information is included in an inner header of the data packet.

5. The non-transitory machine-readable storage medium of claim 4, wherein the inner header comprises an Internet Protocol (IP) header, and the routing information in the IP header comprises a source IP address of a source entity that transmitted data encapsulated by the switch to form the data packet.

6. The non-transitory machine-readable storage medium of claim 2, wherein the switch is an access switch connected over a virtual tunnel to the border device, and the virtual tunnel header of the data packet from the access switch is associated with the virtual tunnel.

7. The non-transitory machine-readable storage medium of claim 6, wherein the access switch comprises a first virtual tunnel endpoint (VTEP) of the virtual tunnel, and the border device comprises a second VTEP of the virtual tunnel.

8. The non-transitory machine-readable storage medium of claim 1, wherein the target device includes a firewall system, and the response packet is the decapsulated packet returned by the firewall system to the border device.

9. The non-transitory machine-readable storage medium of claim 1, wherein the target device includes a remote electronic device outside the computing environment, and the response packet is sent by the remote electronic device as a response to the decapsulated packet.

10. The non-transitory machine-readable storage medium of claim 1, wherein the routing information in the data packet comprises a source network address of a source entity that transmitted data encapsulated by the switch to form the data packet, and wherein the instructions upon execution cause the border device to:
add an entry to the mapping information, the entry correlating the policy tag to the source network address.

11. The non-transitory machine-readable storage medium of claim 10, wherein the routing information in the data packet further comprises a source port number of a port of the source entity, and wherein the instructions upon execution cause the border device to:
add an entry to the mapping information, the entry correlating the policy tag to the source network address and the source port number.

12. The non-transitory machine-readable storage medium of claim 1, wherein the instructions upon execution cause the border device to:
extract routing information from the response packet;
perform a lookup of the mapping information using the routing information extracted from the response packet; and
include, in the header of the encapsulated data packet, the policy tag in an entry of the mapping information retrieved by the lookup.

13. The non-transitory machine-readable storage medium of claim 12, wherein the routing information extracted from the response packet includes an Internet Protocol (IP) address from a source IP field of the response packet.

14. The non-transitory machine-readable storage medium of claim 12, wherein the routing information extracted from the response packet includes an Internet Protocol (IP) address from a destination IP field of the response packet.

15. The non-transitory machine-readable storage medium of claim 1, wherein the policy tag in the encapsulated data packet sent to the destination entity is for use by a switch in applying the policy with respect to a communication including the encapsulated data packet.

16. A border device comprising:
a hardware processor; and
a non-transitory storage medium storing instructions executable on the hardware processor to:
receive, at the border device, an encapsulated data packet from a switch in a computing environment, the encapsulated data packet comprising a virtual tunnel header containing a policy tag indicating a policy to apply to the encapsulated data packet;
extract, at the border device, the policy tag from the virtual tunnel header and routing information from an inner header of the encapsulated data packet;
add an entry to mapping information, the entry correlating the policy tag to the routing information;
send, from the border device to a target device outside the computing environment, a decapsulated packet produced by removing the virtual tunnel header from the encapsulated data packet;
receive, at the border device, a response packet sent by the target device;
generate an encapsulated response packet by adding a virtual tunnel header to the response packet, the virtual tunnel header added to the response packet comprising the policy tag retrieved from the entry of the mapping information based on routing information in the response packet; and
transmit, from the border device, the encapsulated response packet to a destination entity.

17. The border device of claim 16, wherein the routing information comprises an Internet Protocol (IP) address of a source entity that sent a data packet encapsulated by the switch to produce the encapsulated data packet, and wherein the entry added to the mapping information comprises the IP address of the source entity.

18. The border device of claim 17, wherein the routing information further comprises a port number of a port of the source entity, and wherein the entry added to the mapping information comprises the IP address and the port number, and the entry correlates the policy tag to the IP address and the port number.

19. A method comprising:
receiving, at a border device, an encapsulated data packet over a virtual tunnel from a switch in a computing environment, the encapsulated data packet comprising a virtual tunnel header containing a policy tag indicating a policy to apply to the encapsulated data packet;
extracting, by the border device, the policy tag from the virtual tunnel header and routing information from an inner header of the encapsulated data packet;
adding, by the border device, an entry to mapping information, the entry correlating the policy tag to the routing information;
sending, from the border device to a target device outside the computing environment, a decapsulated packet produced by removing the virtual tunnel header from the encapsulated data packet;
receiving, at the border device, a response packet sent by the target device;
extracting, by the border device, response routing information from the response packet;
accessing, by the border device, the entry of the mapping information based on the response routing information;
generating, by the border device, an encapsulated response packet by adding a virtual tunnel header to the response packet, the virtual tunnel header added to the response packet comprising the policy tag retrieved from the entry; and
transmitting, from the border device, the encapsulated response packet to a destination entity.

20. The method of claim 19, wherein the routing information extracted from the inner header of the encapsulated data packet comprises an Internet Protocol (IP) address of a source entity that sent a data packet encapsulated by the switch to produce the encapsulated data packet, and the entry of the mapping information correlates the policy tag to the routing information comprising the IP address.
